(19) United States
(12) Patent Application Publication
(10) Pub. No.: US 2026/0234989 A1
(43) Pub. Date: Aug. 13, 2026

(54) THERMALLY BROKEN TRIMLESS DOOR

(71) Applicant: Alain Gadoury, Anmore (CA)

(72) Inventor: Alain Gadoury, Anmore (CA)

(21) Appl. No.: 19/538,237

(22) Filed: Feb. 12, 2026

Related U.S. Application Data
(60) Provisional application No. 63/758,075, filed on Feb. 13, 2025.

(51) Int. Cl. E06B 3/70; B60J 5/04; B60R 13/02; E06B 1/30; E06B 3/263; E06B 3/58

(52) U.S. Cl. CPC E06B 3/7001; B60J 5/0402; B60J 5/0444; B60J 5/0476; B60R 13/02; E06B 1/30; E06B 3/26303; E06B 3/5892

(57) ABSTRACT

A trimless frame assembly for retaining a panel includes a plurality of trimless frame segments and a panel having a plurality of sides. Each of the plurality of trimless frame segments includes an elongated front wall, an elongated back wall substantially parallel to the elongated front wall, and a gripping assembly in between the elongated front wall and elongated back wall. The gripping assembly includes a gripping channel including a plurality of spaced-apart internal surfaces and a plurality of clip-shaped abutments, each on a respective one of the plurality of spaced-apart internal surfaces such that a side of a panel can be received and gripped by the plurality of clip-shaped abutments. Each of the plurality of sides of the panel is within a respective gripping channel of a respective one of the plurality of trimless frame segments. The elongated front wall and the elongated back wall of each of the plurality of trimless frame segments are thermally separated by at least one thermal break strip.

### CROSS REFERENCE TO RELATED APPLICATION

This application claims the benefit of U.S. Provisional Patent Application No. 63/758,075, filed on Feb. 13, 2025, the disclosure of which is hereby incorporated by reference in its entirety for all purposes.

### FIELD

The present disclosure relates generally for a frame assembly for a door or window and, more particularly, to a trimless frame assembly for a door having an interior panel.

### BACKGROUND

A frame assembly may be used to receive and retain a piece of material (e.g., glass, wood, metal such as aluminum, etc.) for use as a door or window. Such a door or window may be attached to a partition wall by one or more hinges that allow it to be moved between various opened or closed positions. Alternatively, such a door or window may be fixed into slide rails and thereby slidable back and forth. Depending on the material retained by a frame assembly, the door or window may present a transparent, a translucent, or an aesthetic view.

Conventional glass doors have an aluminum frame assembly and an interior glass panel. The glass panel is held in place by the frame assembly's trim. The use of trim to retain an interior panel has several disadvantages. First, it requires many components. A conventional trim assembly can often include eight individual components. This number of components makes the door more expensive and the assembly more complex. In addition, the more components a door has, the more that components can fail. Second, it has security vulnerabilities. To enter a building or a room through an aluminum door, the intruder can simply remove the trim and then easily remove the glass panel and enter the room through the frame assembly which once held the glass panel. Third, the trim detracts from the overall visual appeal of the door by blocking the view of the glass panel. These disadvantages are particularly problematic in exterior applications.

The present disclosure is directed to overcoming these and other problems of the prior art.

### SUMMARY

Embodiments of the present invention address and overcome one or more of the above shortcomings and drawbacks, by a trimless frame assembly for a door or window.

In an exemplary embodiment, a trimless frame assembly for retaining a panel includes a plurality of trimless frame segments and a panel having a plurality of sides. Each of the plurality of trimless frame segments includes an elongated front wall, an elongated back wall substantially parallel to the elongated front wall, and a gripping assembly in between the elongated front wall and elongated back wall. The gripping assembly includes a gripping channel including a plurality of spaced-apart internal surfaces and a plurality of clip-shaped abutments, each on a respective one of the plurality of spaced-apart internal surfaces such that a side of a panel can be received and gripped by the plurality of clip-shaped abutments. Each of the plurality of sides of the panel is within a respective gripping channel of a respective one of the plurality of trimless frame segments. The elongated front wall and the elongated back wall of each of the plurality of trimless frame segments are thermally separated by at least one thermal break strip.

In some embodiments, the plurality of spaced apart internal surfaces includes an internal front surface spaced-apart from and substantially parallel to the elongated front wall, an internal back surface spaced-apart from and substantially parallel to the elongated back wall, and an internal connecting surface connecting the internal front surface to the internal back surfaces.

In some embodiments, the plurality of trimless frame segments include a top segment and a bottom segment, and each of the top and bottom segments include an internal intermediate wall connecting the elongated front wall to the elongated back wall such that an elongated channel is formed by the elongated front wall, the internal intermediate wall, and the elongated back wall. In some embodiments, the trimless frame assembly further includes a rod proximate the bottom segment to about which the bottom segment can pivot such that the trimless frame assembly forms a swinging door. In some embodiments, the trimless frame assembly further includes an elongated reinforcement bar in the top segment between its elongated front wall and elongated back wall and a hardware component connected to the elongated reinforcement bar at a hardware aperture formed through the top segment. In some embodiments, the hardware component is one of a door opener and a door closer.

In some embodiments, wherein the plurality of trimless frame segments include a left segment and a right segment, and each of the left and right segments includes an elongated back side wall connecting the elongated front wall to the elongated back wall.

In some embodiments, the trimless frame assembly further includes an elongated reinforcement bar in the left segment between the elongated front wall and the elongated back wall and a hardware component connected to the elongated reinforcement bar at a hardware aperture formed through the left segment. In some embodiments, the hardware component is a lockset. In some embodiments, the hardware component is a hinge plate configured to be attached to a partition wall such that the trimless frame assembly forms a swinging door. In some embodiments, the thermal break strip comprises a strip of polyamide. In some embodiments, the thermal break strip includes a strip of polyamide in the gripping channel.

In some embodiments, the trimless frame assembly includes top, bottom, left, and right frame segments. The top and bottom frame segments each include an internal intermediate wall connecting the elongated front wall to the elongated back wall such that an elongated channel is formed by the elongated front wall, the internal intermediate wall, and the elongated back wall. The left and right frame segments each include an elongated back side wall connecting the elongated front wall to the elongated back wall. The top segment is connected to a respective first end of the left segment and the right segment, and the bottom segment is connected to a respective second end of the left segment and the right segment.

In some embodiments, each of the plurality of trimless frame segments is made of a single piece of material. In some embodiments, each of the plurality of trimless frame segments are made of aluminum and the panel is made of glass. In some embodiments, the trimless frame assembly further includes a plurality of gaskets, each of the plurality of gaskets within a respective one of the plurality of clip-shaped abutments.

In another exemplary embodiment, a trimless frame segment for retaining a panel includes an elongated front wall, an elongated back wall substantially parallel to the elongated front wall, and a gripping assembly in between the elongated front wall and elongated back wall. The gripping assembly includes a gripping channel including a plurality of spaced-apart internal surfaces, and a plurality of clip-shaped abutments. Each on a respective one of the plurality of spaced-apart internal surfaces such that a side of a panel can be received and gripped by the plurality of clip-shaped abutments.

In some embodiments, the trimless frame segment further includes a plurality of gaskets, each of the plurality of gaskets within a respective one of the plurality of clip-shaped abutments. In some embodiments, the plurality of spaced apart internal surfaces includes an internal front surface spaced-apart from and substantially parallel to the elongated front wall, an internal back surface spaced-apart from and substantially parallel to the elongated back wall, and an internal connecting surface connecting the internal front surface to the internal back surfaces. In some embodiments, the trimless frame segment further includes an internal intermediate wall connecting the elongated front wall to the elongated back wall such that an elongated channel is formed by the elongated front wall, the internal intermediate wall, and the elongated back wall. In some embodiments, the trimless frame segment further includes an elongated back side wall connecting the elongated front wall to the elongated back wall. In some embodiments, wherein the trimless frame segment is made of a single piece of material comprising aluminum. In some embodiments, the thermal break strip comprises a strip of polyamide. In some embodiments, the thermal break strip includes a strip of polyamide in the gripping channel.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present disclosure are best understood from the following detailed description when read in connection with the accompanying drawings. For the purpose of illustrating the disclosure, there are shown in the drawings embodiments that are presently preferred, it being understood, however, that the disclosure is not limited to the specific instrumentalities disclosed. Included in the drawings are the following Figures:

FIGS. 1A-1D are various views of a conventional aluminum door with trim retaining an interior glass panel.

FIG. 2 illustrates a trimless horizontal segment, according to an embodiment of the disclosure.

FIG. 3 illustrates a trimless vertical segment, according to an embodiment of the disclosure.

FIG. 4 illustrates how a trimless horizontal segment can be connected to a trimless vertical segment, according to an embodiment of the disclosure.

FIG. 5 is an exploded view of a trimless door formed by four trimless segments connecting together and retaining an interior panel, according to an embodiment of the disclosure.

FIG. 6A-6C are various views of a swinging trimless door, according to an embodiment of the disclosure.

FIGS. 7A and 7B illustrate a hinge plate installed on a trimless door, according to an embodiment of the disclosure, and a hinge plate installed on a conventional door, respectively.

FIGS. 8A and 8B illustrate various embodiments of an elongated reinforcement member, according to the disclosure.

FIGS. 9A and 9B are various views of a trimless door with a middle rail, according to an embodiment of the disclosure.

FIGS. 10A-10D are various views of a trimless swinging door, according to an embodiment of the disclosure.

FIG. 11 illustrates a thermally-broken horizontal segment, according to an embodiment of the disclosure.

FIG. 12 illustrates a thermally-broken vertical segment, according to an embodiment of the disclosure.

### DETAILED DESCRIPTION

The present disclosure describes a trimless frame assembly for a door or window. These embodiments are particularly advantageous when used in an exterior door or window that benefits from thermal insulation. In thermal insulation applications, care should be taken to ensure that metal or other thermally-conductive elements do not conduct much heat through the door. This conduction can be minimized by introducing a rigid, non-conductive material between the inside and outside faces of the door frame, such as a polyamide thermal break strip. Insulation can also be added to the voids or gaps within the door frame to increase the R-value of the frame.

The door frame assembly includes the structural elements of a door panel, such as rails, stiles, mullions, transoms, and panels such as recessed or raised panels or glass. Colloquially, the term can include the casing, jamb, and stop, but these elements will be identified separately, where relevant. In disclosed embodiments, the frame assembly is formed by four trimless frame segments (and can include more if mullions and transoms are used). Each frame segment has a gripping assembly formed by three spaced-apart gripping channels. In some embodiments, one or more of the gripping channels retains a gasket. One side of a panel, e.g., a glass panel, can be inserted into, and retained by, the gripping assembly of the trimless frame segment. The use of the gripping assembly obviates the need for trim or glazing strips/putty. To assemble a trimless door or window, each side of a glass panel is inserted into a trimless frame segment, and each frame segment is connected to its neighboring frame segment. In this manner, the frame can be built up around the panel, in some embodiments. In some embodiments, the frame can utilize extrusions (e.g. aluminum) that have an inner and outer portion separated by one or more polymer thermal break strips (e.g. polyamide) to minimize thermal conduction between the inside and outside of the door when used in an exterior application.

Each trimless frame segment can be made by extruding a material through a die to form one continuous trimless frame segment. In this way, a trimless frame segment may be made of a solid continuous piece of material. In some embodiments, the trimless frame segment is made from aluminum, but other extrudable materials are also possible, such as, for example and not limitation, plastic and fiberglass. The panel retained by the trimless frame segments can be made of any material, but glass will be the primary example discussed.

There are several advantages to providing a frame assembly without trim. First, it reduces the number of components. With fewer components, there will be fewer components to purchase, which can make the segment cheaper, and fewer components that can fail, which can make the segment less likely to break. In addition, the less components a door has, the fewer components that can fail. Second, it improves security. While it is relatively easy for an intruder to remove the glass panel of a conventional aluminum door by removing its trim, an intruder must break the glass panel of the trimless door described herein. Third, trimless door is more visually appealing than a door with trim.

Although certain examples of the disclosed technology are explained in detail, it is to be understood that other examples, embodiments, and implementations of the disclosed technology are contemplated. Accordingly, it is not intended that the disclosed technology is limited in its scope to the details of construction and arrangement of components set forth in the following description or illustrated in the drawings. The disclosed technology can be implemented in a variety of examples and can be practiced or carried out in various ways. In particular, the presently disclosed subject matter is described in the context of forming a trimless door. The present disclosure, however, is not so limited, and can be applicable to other applications. The present disclosure, for example and not limitation, can include forming a trimless window or any other product with a frame and a piece of material retained within the frame. Such implementations and applications are contemplated within the scope of the present disclosure. Accordingly, when the present disclosure is described in the context of a trimless door, it will be understood that other implementations can take the place of those referred to.

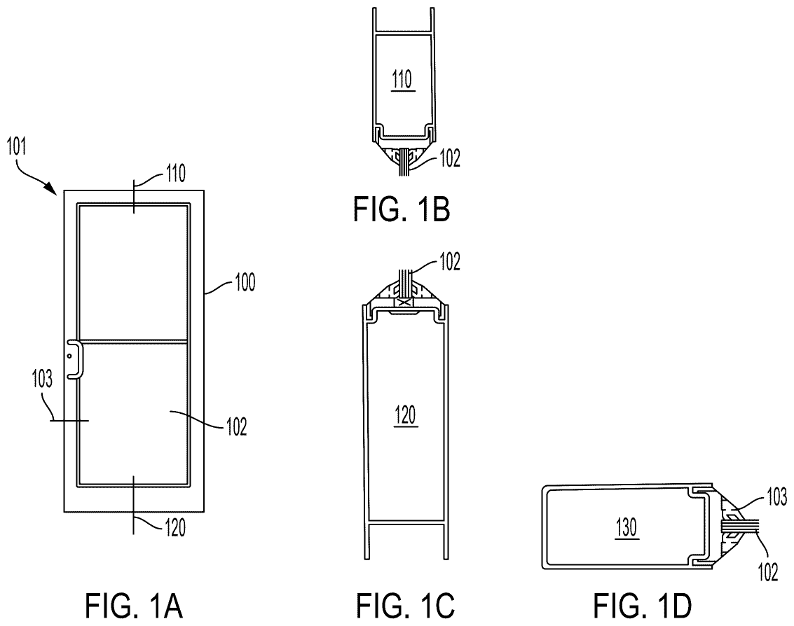

Turning now to the figures, FIGS. 1A-1D are various views of a conventional aluminum door with trim retaining an interior glass panel. Conventional glass doors 101 have an aluminum frame assembly 100 and an interior glass panel 102. The glass panel 102 is held in place by trim assemblies 103, which each often contain eight individual components. While one conventional aluminum door design is illustrated in FIGS. 1A-1D, there are many different types of clips and many manufacturers have their own unique configuration and dies.

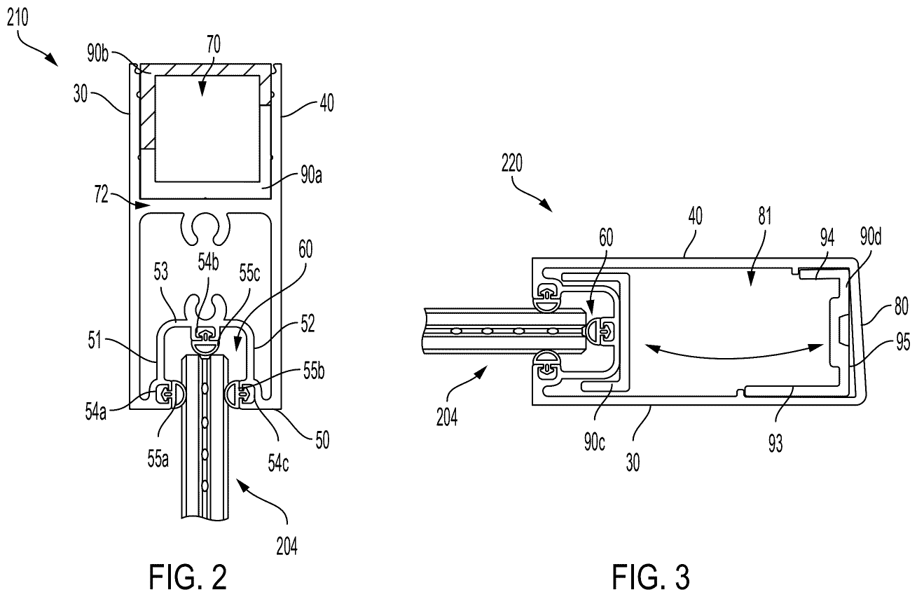

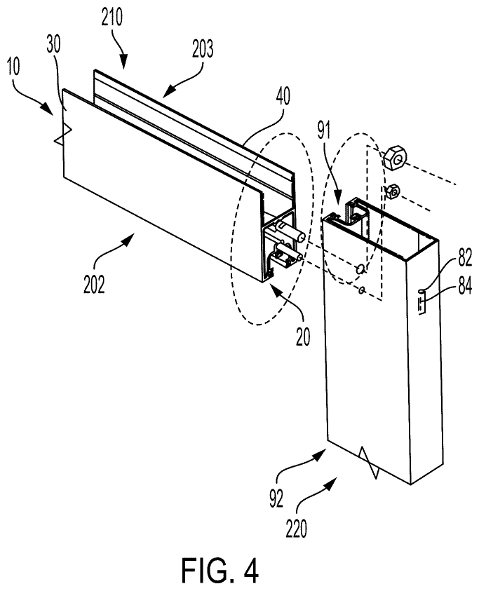

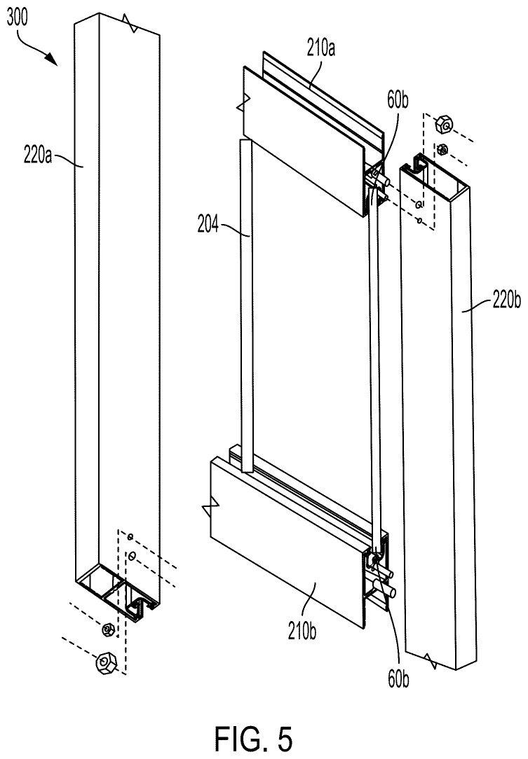

FIGS. 2 and 3 each illustrates an embodiment trimless segment, according to embodiments of the disclosure. FIG. 2 illustrates a trimless horizontal segment 210 (i.e., a rail segment) and FIG. 3 illustrates a trimless vertical segment 220 (i.e., a stile segment), each according to an embodiment of the disclosure. FIGS. 2 and 3 each also illustrate multiple locations at which elongated reinforcement bars 90 can be used for reinforcement. FIG. 4 illustrates how a trimless horizontal segment 210 can be connected to a trimless vertical segment 220, according to an embodiment of the disclosure, and FIG. 5 is an exploded view of a trimless door 300 formed by four trimless segments connecting together and retaining an interior panel 204, according to an embodiment of the disclosure.

Returning to FIG. 2, as mentioned above, FIG. 2 illustrates a trimless horizontal segment 210, according to an embodiment of the disclosure.

A horizontal frame segment 210 has a first end 10 and a second end 20 (shown in FIG. 4). The horizontal frame segment 210 has a gripping side 202 and an open side 203 (as shown in FIG. 4). The gripping side 202 has features that allow it to grip a piece of material 204 without the use of trim.

The horizontal frame segment 210 has an elongated front wall 30 and an elongated back wall 40 (see FIG. 4). The front wall 30 and back wall 40 extend between the first end 10 and second end 20 and are substantially parallel with each other.

The horizontal segment 210 also has an internal intermediate wall 72. The internal intermediate wall 72 may extend substantially perpendicularly from the front wall 30 to the back wall 40 along the longitudinal axis 201. The internal intermediate wall 72 forms an elongated channel 70 between the front wall 30 and the back wall 40 opposite the open side 203.

The horizontal segment 210 also has an elongated front side wall 50. The elongated front side wall 50 may extend between the first end 10 and second end 20 and connects the front wall 30 and back wall 40 at the gripping side 202. The front side wall 50 is not a flat surface. Instead, the front side wall 50 forms an elongated gripping channel 60. The elongated gripping channel 60 extends through the frame segment 200 from the first end 10 to the second end 20.

In the gripping channel 60, there is a pair of spaced-apart surfaces: an internal front surface 51 and an internal back surface 52. The internal front surface 51 and internal back surface 52 extend between the first end 10 and second end 20 along the longitudinal axis 201. The gripping channel 60 also has an internal connecting surface 53 that connects the internal front surface 51 and internal back surface 52. Three clip-shaped abutments 54a-54c are provided in the gripping channel 60, one on each of the three internal surfaces 51, 52, 53. Optionally, in some embodiments, each of the clip-shaped abutments 54a-54c can be capable of receiving and retaining an elongated resilient gasket 55a-55c. With or without elongated resilient gaskets 55a-55c inserted into the clip-shaped abutments 54a-54c, the horizontal segment 210 can receive and retain a piece of material 204, to secure the piece of material 204 in place. In this way, the piece of material 204 is “sandwiched” or “gripped” by the gripping channel 60.

In some embodiments, the clip-shaped abutments 54 and the elongated resilient gaskets 55 extend from the first end 10 all the way to the second end 20, having substantially the same length as the gripping channel 60. In other embodiments, the elongated resilient gaskets 55 may be shorter, and there may be several segments of elongated resilient gaskets 55 within the clip-shaped abutment 54. In other embodiments, one or more of the clip-shaped abutments 54 may be formed by several clip-shaped abutments in series and spread out along the internal surfaces 51, 52 and/or 53, each retaining an elongated resilient gasket 55 of substantially the same length.

When installed in this location on a horizontal segment 210 used for the top of a trimless door, the elongated reinforcement bar 90 can provide reinforcement for a closer. And, as mentioned above, FIG. 2 illustrates multiple locations at which elongated reinforcement bars 90 can be used for reinforcement. For example, an elongated reinforcement bar 90a can be connected to the internal intermediate wall 72 on the elongated channel 70 side. For another example, an elongated reinforcement bar 90b can be connected to the inner surfaces of the front wall 30 and back wall 40 such that the back supporting wall 95 of the elongated reinforcement bar 90b forms a flush top cap to close off the elongated channel 70.

Turning now to FIG. 3, FIG. 3 illustrates a trimless vertical segment 220, each according to an embodiment of the disclosure. In many ways, the trimless vertical segment 220 has a similar structure to that of the trimless horizontal segment 210, as illustrated and discussed with respect to FIG. 2. However, unlike the horizontal segment 210, the vertical segment 220 has an elongated back side wall that can extend between the first end 10 and the second end 20 along a longitudinal axis (perpendicular to the page). The elongated back side wall 80 connects and thereby seals the front wall 30 to the back wall 40 on the open side 203, forming an internal reinforcing channel 81.

In some embodiments, the internal reinforcing channel 81 can include an elongated reinforcement member 90d along the back side wall 80. The elongated reinforcement member 90d can extend along the longitudinal axis (perpendicular to the page) and has a first reinforcement end 91 and a second reinforcement end 92 (as shown in FIG. 4). The first and second reinforcement ends 91, 92 can be substantially aligned with the first end 10 and second end 20 of the vertical segment 220, respectively. In some embodiments, the entirety of the elongated reinforcement member 90d may be disposed within the internal reinforcing channel 81. The elongated reinforcement member 90d may be secured to the back side wall 80 and vertically support the back side wall 80 (e.g., at the reinforcement ends 91, 92). The vertical support may be desired for example, for security purpose or to meet local fire rating requirement.

The elongated reinforcement member 90d has a back supporting reinforcement wall 95 extending between the first reinforcement end 91 and the second reinforcement end 92. The back supporting reinforcement wall 95 may be disposed against the back side wall 80 such that the elongated reinforcement member 90d is secured to the back side wall 80 via the back supporting reinforcement wall 95.

In some embodiments, such as the embodiment shown in FIG. 3, the elongated reinforcement member 90d also has a front reinforcement wall 93 and back reinforcement wall 94 that each extend from the back supporting reinforcement wall 95. The front reinforcement wall 93 and the back reinforcement wall 94 can be disposed against the front wall 30 and the back wall 40, respectively, and can extend between the first reinforcement end 91 and the second reinforcement end 92. More information regarding the reinforcement member 90d is described in U.S. Pat. No. 8,713,866, entitled “Hinge Reinforced Frame Assembly,” which is incorporated herein in its entirety by reference.

In addition to vertically supporting the back side wall 80, the elongated reinforcement member 90d may also provide reinforcement when the vertical segment 220 is used as a hinge side stile of a door. Specifically, when such a door is mounted to a door fame via one or more hinge plates, the elongated reinforcement member 90d may provide reinforcement for the hinge plates such that hinges may be fastened onto the door in a more stable way. This will be described in further detail below. Therefore, with the elongated reinforcement member 90d, the vertical segment 220 may be suitable to be arranged as a hinge side stile for a door or window, to mount the door or window to a door frame or window frame or simply to a partition wall.

In some embodiments, such as the embodiment shown in FIG. 4, trimless vertical segment 220b includes a hinge aperture 82 on its back side wall 80 of the segment. The hinge aperture 82 may receive a hinge plate 83 therein. In the embodiment shown in FIG. 4, the vertical segment 220 can be mounted to a partition wall via the hinge plate 83 (see other figures). The hinge plate 83 may be retained in the hinge aperture 82. To mount the vertical segment 220 directly to a door frame or to an intermediate component that mounts to a door frame, the back side wall 80 can also have one or more mounting holes 84. In embodiments in which the back side wall 80 has the reinforcement member 90d, the reinforcement member 90d can also have corresponding mounting holes 84 for securing the hinge plate 83 thereto. Although only one hinge aperture 82 is illustrated in FIG. 5, a plurality of hinge apertures 82 may be arranged along the back side wall 80, as would be appreciated by one of ordinary skill in the art. Those arranged hinge apertures 82 may be spread out on the back side wall 80 substantially evenly or equidistantly between the first end 10 and the second end 20.

As mentioned above, FIG. 3 also illustrates multiple locations at which elongated reinforcement bars 90 can be used for reinforcement. As described in the preceding paragraphs, an elongated reinforcement bar 90d can be secured to the back side wall 80 of the vertical segment 220. But other locations for the elongated reinforcement bar are also possible. For example, an elongated reinforcement bar 90c can also be connected within the internal reinforcing channel 81 on the internal surfaces 51, 52, 53 that together form the gripping channel 60, on the walls opposite the gripping channel there is a pair of spaced-apart surfaces.

Turning now to FIG. 4, FIG. 4 illustrates how a trimless horizontal segment 210 can be connected to a trimless vertical segment 220, according to an embodiment of the disclosure. The horizontal 210 and vertical 220 segments can be attached in any way known in the art. For example, in the embodiment shown in FIG. 4, the segments 210, 220 are connected with screws (e.g., socket set screws and lock nuts). As will be appreciated by one of ordinary skill in the art, each of two horizontal segments 210 can be connected as illustrated in FIG. 4 to two vertical segments to form a rectangle.

FIG. 5 is an exploded view of a trimless door 300, according to an embodiment of the disclosure. As illustrated in FIG. 5, a trimless door 300 can be formed by inserting each side of a panel 204 into a respective gripping channel 60 of a respective trimless frame segment and then connecting neighboring trimless frame segments. The top and bottom of the frame can be substantially parallel to each other and are horizontal segments 210a and 210b while the left and right of the frame can be substantially parallel to each other and are vertical frame segments 220.

As illustrated in FIG. 5, a single panel of material 204 can be inserted into the gripping channels 60 of the top horizontal segment 210a and the bottom horizontal segment 210b, respectively, and gripped by the respective gripping channels 60 therein. Accordingly, the panel of material 204 is secured between the front wall 30 and back wall 40 of the top horizontal segment 210a, and between the front wall 30 and back wall 40 of the bottom horizontal segment 210b. Then, the single panel of material 204 can be inserted into the gripping channels 60 of the left vertical segment 220a and the right vertical segment 220b, respectively, and gripped by the respective gripping channels 60 therein. Accordingly, the panel of material 204 is secured between the front wall 30 and back wall 40 of the left vertical segment 220a, and between the front wall 30 and back wall 40 of the right vertical segment 220b. Then the top horizontal segment 210a and the bottom horizontal segment 210b may be connected to the left vertical segment 220a and the right segment 220b (e.g., in a way similar as illustrated in FIG. 4).

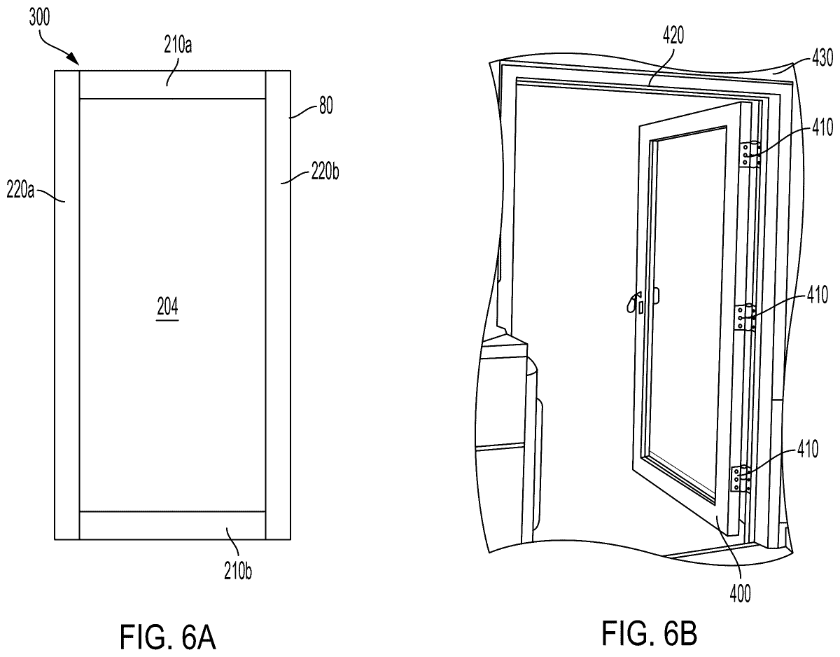

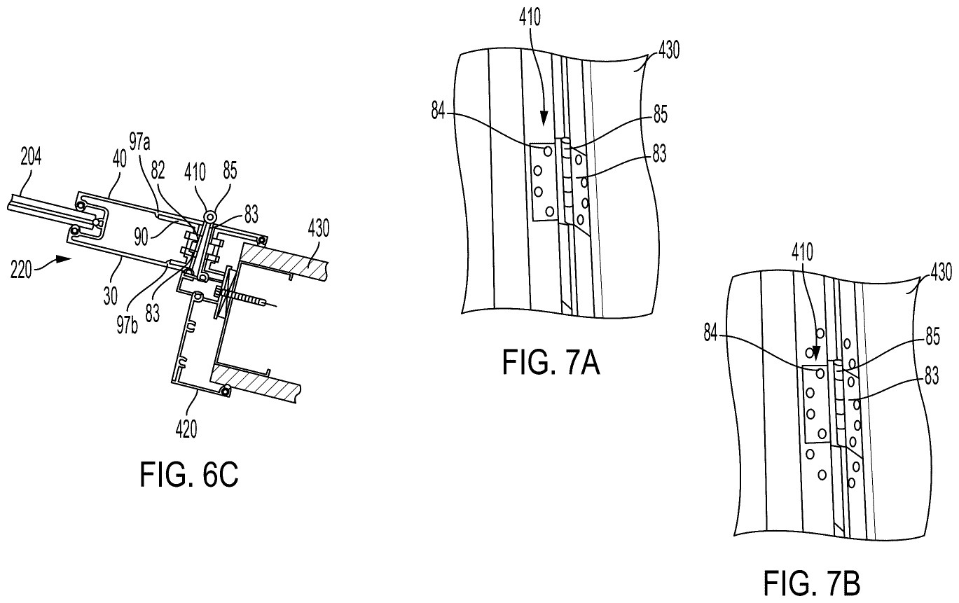

FIG. 6A-6C are various views of a swinging trimless door 300, according to an embodiment of the disclosure. FIG. 6A is a front view of a swinging trimless door 300, FIG. 6B is an isometric view of a swinging trimless door 300, and FIG. 6C is a cross-sectional view of how the swinging trimless door 300 connectors to a door frame, each according to an embodiment of the disclosure.

An exemplary door 300 is shown in FIG. 6B, and a connection assembly 410 that mounts the door 300 to a partition wall 420 is shown in FIG. 6C. A trimless door 300 has a frame assembly formed by at least two horizontal segments 210a, 210b and at least two vertical segments and a piece of material 204 being gripped by the trimless segments after the assembly process. In some embodiments, the back side wall 80 of one of the vertical segments, in FIG. 6A, the right vertical segment 220b, can have one or more hinge apertures 82 for receiving a respective hinge plate 83 therein.

The frame assembly can be connected to a door frame by connecting a vertical segment 220 to a connection assembly 410, and connecting the connection assembly 410 to a partition wall 430. The door 300 shown in FIG. 6B is secured to a partition wall 430 by three connection assemblies 410. As illustrated in the detailed view of one connection assembly 410 in FIG. 6C, door 300 can be mounted to a partition wall 430 via a hinge plate 83 having a plurality of mounting holes 84 thereon. As illustrated in FIG. 6C, the connection assembly 410 can include one or more hinge plates 83 and any other components and members necessary or helpful to mount the door 300 to a partition wall 430 (e.g., nuts, bolts, screws). The hinge plate 83 may allow door 300 to be rotatable along hinge 85 such that door 300 may be opened or closed at various positions.

It is to be understood that a plurality of connection assemblies 410 and therefore a plurality of hinge plates 83 may be used. In addition, it is to be understand that a door 300 can be inserted and thus installed into an opening of a wall, and can either be moveable or non-movable. In some embodiments, a door 300 may not be opened and closed along the hinge 85, but may be slidable back and forth, depending on the design or character of the wall 430 to which the door 300 will be mounted and the other assemblies that are attached to the door 300.

FIGS. 7A and 7B illustrate a hinge plate 83 installed on a trimless door, according to an embodiment of the disclosure, and a hinge plate 83 installed on a conventional door, respectively. The stile in FIG. 7A has four mounting holes while the stile in FIG. 7B has eight. The reduction in the number of mounting holes is due to the use of the elongated reinforcement member 90. Use of the elongated reinforcement member can be desirable whenever hardware with tabs are used. Tabs refer to short (~5×1−1/2″) aluminum/metal plates fastened to the door assembly for each piece of hardware on the door, typically using 4 screws per tab, as illustrated above and below the hinge plate in FIG. 7B. For example, a door using 3 hinges and 1 deadlock would conventionally have four tabs and sixteen screws. In contrast, the door described herein, with an elongated reinforcement member 90, uses only two parts to do this job: two of the elongated reinforcement members 90, one at the hinge style to connect to the hingers and one at the locking stile for the deadlock. Accordingly, use of the technology described herein, reduces the number of parts (20 vs. 2) and thus reduces manufacturing time.

As mentioned above, the use of an elongated reinforcement member 90 can be advantageous in one or more of the trimless segments 210, 220b. For example, it may be desirable to include a reinforcement member on each of the four sides of a door 300, each of the three sides of a door frame, and one or all sides of a window. When used as a top rail, a horizontal segment 210 with an elongated reinforcement member 90 can provide reinforcement for various hardware installed on the top rail, such as door closers and door openers, for example. When used as a bottom rail, a horizontal segment 210 with an elongated reinforcement member 90 will provide reinforcement for various hardware installed on the bottom rail, such as automatic door bottoms and pivots, for example.

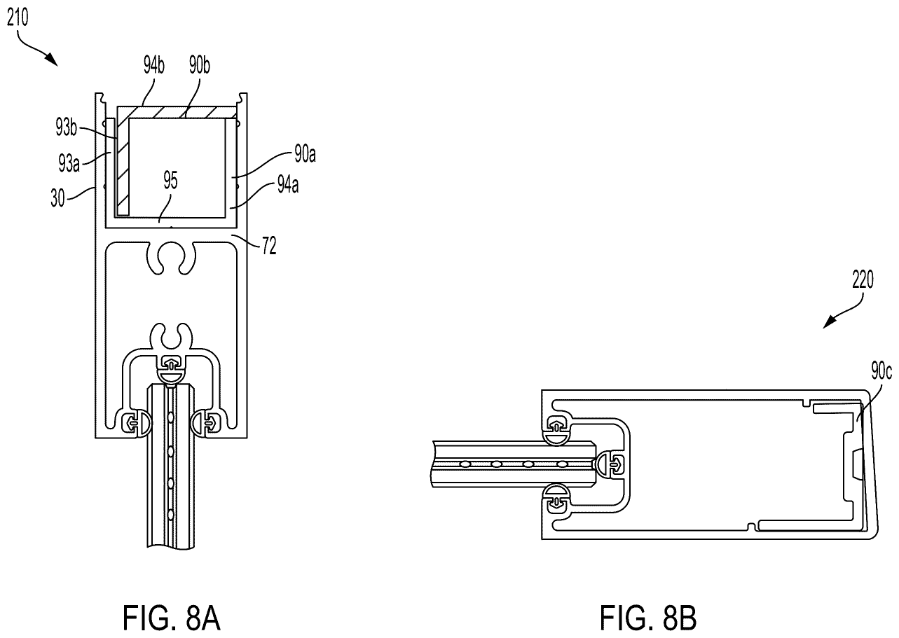

FIGS. 8A and 8B illustrate various embodiments of an elongated reinforcement member, according to the disclosure. FIG. 8A shows two elongated reinforcement bars 90a, 90b in the elongated channel 70. The first elongated reinforcement bar 90a has a front reinforcement wall 93a and back reinforcement wall 94a that each extend from the back supporting reinforcement wall 95. The back supporting reinforcement wall 95 is connected to the internal intermediate wall 72. The second elongated reinforcement bar 90b has only two walls such that it forms the shape of an “L.” The second wall 94b of the second elongated reinforcement bar 90b forms a top cap to close off the elongated channel 70 and the first wall 93b is connected to the front reinforcement wall 93a of the first elongated reinforcement bar 90a such that a triple wall is formed by the front face 30 of the horizontal segment 210, the front reinforcement wall 93a of the first elongated reinforcement bar 90a, and the first wall 93b of the elongated reinforcement bar 90b. This triple wall can be useful for heavy duty applications like a closer bracket reinforcement.

FIG. 8B shows one elongated reinforcement bar 90c. When used as a lock-side stile, a vertical segment 220 with an elongated reinforcement member 90c will provide reinforcement for various hardware installed on the lock-side stile, such as a lockset (deadlocks locks, etc.), for example. When used as a hinge-side stile, a vertical segment 220 with an elongated reinforcement member 90c will provide reinforcement for various hardware installed on the hinge-side style, such as a hinge or a continuous hinge, for example. By implementing the elongated reinforcement member 90c as a continuous member, the elongated reinforcement member 90c may be capable of vertically supporting the frame assembly when mounted substantially vertically and positioning the elongated reinforcement member 90c to rest its base end upon a floor. The elongated reinforcement member 90c may also support the weight and other forces associated with the hanging and operation of a hinge-mounted door or window having its hinge assembly mounted to the elongated reinforcement member 90c, instead of having to translate all such forces through the elongated frame jamb to the partition wall.

As one of ordinary skill in the art will appreciate, the elongated reinforcement member can be made of a solid continuous piece of material that can comprise one or more of metal (e.g., aluminum, steel), wood, or plastic.

Returning to FIG. 6C, in some embodiments, the interior surface of the elongated front wall 30 and/or elongated back wall 40 have elongated reinforcement member 90 retention bodies 97a, 97b. In such embodiments, the elongated reinforcement member 90 is retained in place by snuggly fitting within an interior surface of the trimless frame segment and one or more of the retention bodies 97.

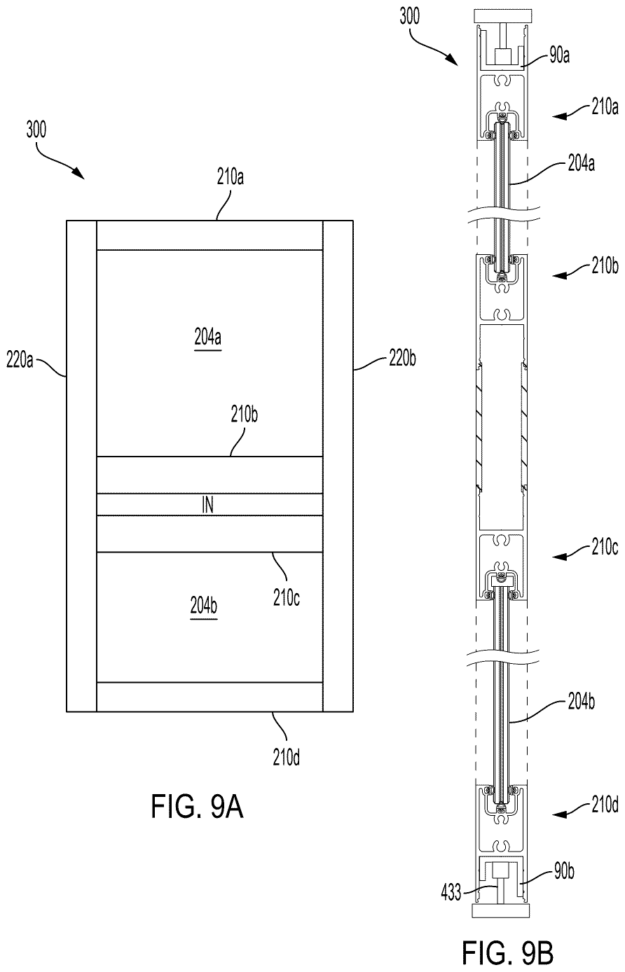

FIGS. 9A and 9B are various views of a trimless door 300 with a middle rail, according to an embodiment of the disclosure. Many different styles of doors can be made using the technology disclosed herein. For example, the door 300 in FIGS. 9A and 9B holds two panels of material 204a, 204b and a middle sign that reads “IN” to communicate that persons should enter through the door. The door 300 has four horizontal segments 210a-210d that are each connected to both vertical segments 220a, 220b. The first panel 204a is gripped by horizontal segments 210a, 210b and vertical segments 220a, 220b, and the second panel 204b is gripped by horizontal segments 210c, 210d and vertical segments 220a, 220b. The middle sign is attached the open sides 203 of each of horizontal segment 210b and 210c.

In some embodiments, the door 300 can further include a rod 433 proximate the bottom horizontal segment 210b about which the bottom horizontal segment 210 can pivot such that the door forms a swinging door.

The trimless door 300 can include an elongated reinforcement bar 90a in its top horizontal segment 210a and another elongated reinforcement bar 90b in its bottom horizontal segment 210b to provide reinforcement for pivots.

In some embodiments the trimless door 300 shown in FIGS. 9A and 9B can be installed via a push-in installation. In such embodiments, the horizontal segments 210a and 210d should be wider than those installed by other methods.

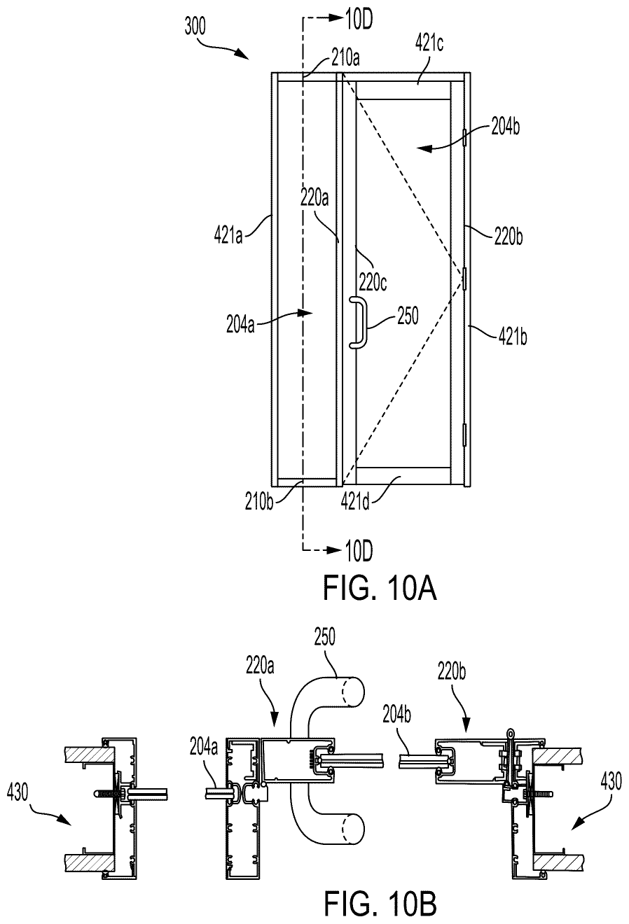

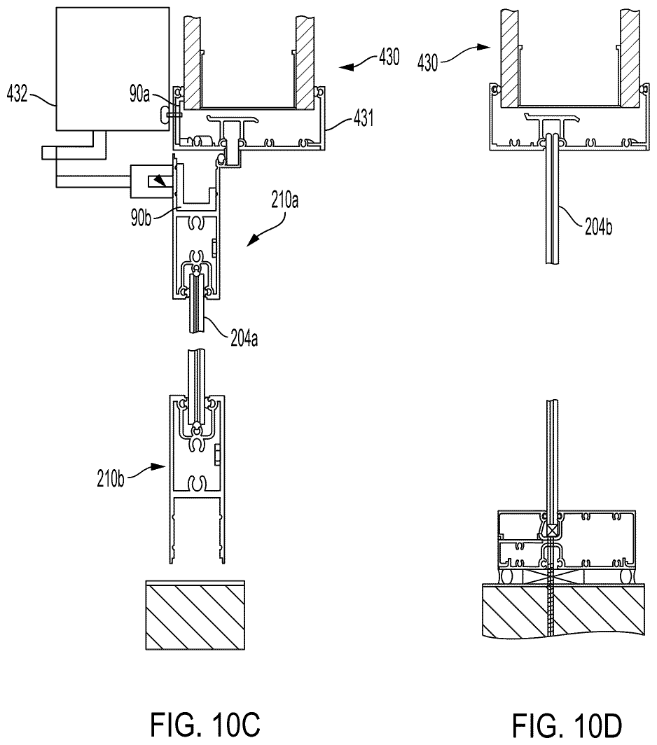

FIGS. 10A-10D are various views of a trimless swinging door 300, according to an embodiment of the disclosure. As mentioned above, many different styles of doors can be made using the technology disclosed herein. The swinging door 300 shown in FIGS. 10A-10D is another example. FIG. 10A is a front view of trimless swinging door 300, according to an embodiment of the disclosure. FIG. 10B is a horizontal cross-section of the trimless swinging door 300 shown in FIG. 10A. FIG. 10C is a vertical cross-section of the trimless swinging door 300 shown in FIG. 10A, through the first panel of material 204a, and FIG. 10D is a side view of the trimless swinging door 300 shown in FIG. 10A, through the second panel of material 204b. As illustrated in FIGS. 10A-10D, the trimless segments disclosed herein are used to hold and retain two panels of material 204a, 204b. In addition, the swinging door also has other assemblies that connect the panels of material or the trimless segments to other assemblies or the partition wall 430 and allow the swinging door to slide (see rotating bodies in FIG. 10D).

With reference to FIG. 10C in particular, horizontal segment 210a and the connection piece 431 between the horizontal segment 210a and the partition wall 430 each include an elongated reinforcement bar 90a, 90b to provide additional reinforcement for the automatic door closer arm and bracket 432.

A method of assembling a trimless door, according to an embodiment of the disclosure can include the following steps: In some embodiments, step 1 can include providing two trimless horizontal segments, two trimless vertical segments, and a panel of material. In some embodiments, step 2 can include inserting a first side of the panel into a first of the four trimless segments. In some embodiments, step 3 can include inserting a second side of the panel into a second of the four trimless segments. In some embodiments, step 4 can include inserting a third side of the panel into a third of the four trimless segments. In some embodiments, step 5 can include inserting a fourth side of the panel into a fourth of the four trimless segments. In some embodiments, step 6 can include connecting each of the trimless segments to its neighboring segments. In some embodiments, step 7 can include installing the trimless door. The trimless door can be installed with or without other components and the final installed door can take the form of, for example, as a swinging door, a stationary or “inactive” door, or a sliding door.

In some embodiments, the trimless segment may be assembled as an aluminum glass door. In some embodiments, 6063-T5 aluminum may be used. In some embodiments, for an enhanced security purpose, thickness of the glass may be limited to between 5 mm to 13.5 mm.

### Thermal Break Applications

In some embodiments, the techniques and structures taught throughout can be applied to exterior doors, which preferably feature a thermal break within the door frame structures. When the frame structures (e.g., those in FIGS. 2, 3, 8a, and 8b) are made from thermally conductive material, such as aluminum and other metals, the frame of the door will conduct heat between the inside and outside face of the door. This is undesirable for most exterior door applications. Therefore, when a door is constructed for exterior use, a thermal break should be built between opposing faces of the door. For example, the extrusions taught throughout can be created in two parts-on for the exterior face of the door and the other for the interior face. These two sections of extrusion can then be joined by a strip of material that is less thermally conductive. In some embodiments a strip of polymer, such as polyamide, is used as a thermal break strip between two sections (i.e., interior and exterior faces) of an aluminum frame. This physically couples the interior and exterior portions of the frame, while thermally isolating them to minimize heat transfer. Because the polymer conducts less heat than the aluminum frame, the strip of polymer creates a thermal break between the two sides of the door. For example, aluminum has a thermal conductivity of over 200 W/m·K, while polyamide has a thermal conductivity of less than 1 W/m·K. Thus, thermal isolation does not require perfect isolation/separation, but the thermal break material has a conductivity substantially less (e.g. less than 1 W/m·K) than the structural frame material.

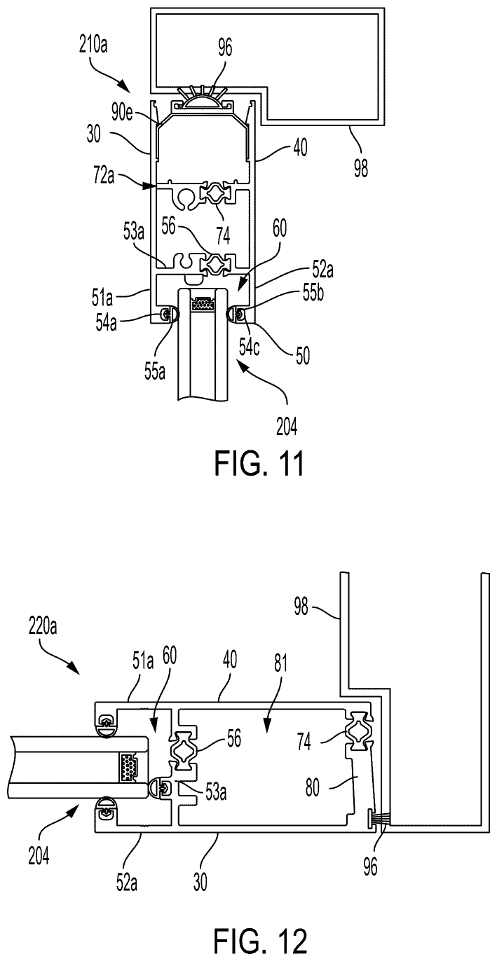

FIGS. 11 and 12 show cross sections of a thermally broken door version of the door shown in FIGS. 2 and 3, respectively. Like with the frame segments shown in FIGS. 2 and 3, a horizontal frame segment 210a has a first end 10 and a second end 20 (similar to that shown in FIG. 4 without thermal breaks). The horizontal frame segment 210a has a gripping side 202 and an open side 203 (similar to that shown in FIG. 4 without thermal breaks). The gripping side 202 has features that allow it to grip a piece of material 204 without the use of trim.

The horizontal frame segment 210a has an elongated front wall 30 and an elongated back wall 40. The front wall 30 and back wall 40 extend between the first end 10 and second end 20 and are substantially parallel with each other.

The horizontal segment 210a also has an internal intermediate wall 72a. The internal intermediate wall 72a may extend substantially perpendicularly from the front wall 30 to the back wall 40 along the longitudinal axis 201. The internal intermediate wall 72a forms an elongated channel 70 between the front wall 30 and the back wall 40 opposite the open side 203. Intermediate wall 72a differs from wall 72 in FIG. 2 because it includes thermal break strip 74, which (along with thermal break strip 56) forms a thermal break between front wall 30 and back wall 40. In this embodiment, front wall 30 would be the exterior face of an exterior architectural door, while back wall 40 would be the interior face (or vice versa). Thermal break strip 56 breaks up internal surface 53a of gripping channel 60, while thermal break strip 74 breaks up wall 72a. together these create a thermal break in horizontal segment 210a. In some embodiments, the void between surface 53a and wall 72a can be filled with insulating foam.

The horizontal segment 210a also has an elongated front side wall 50. The elongated front side wall 50 may extend between the first end 10 and second end 20 and connects the front wall 30 and back wall 40 at the gripping side 202. The front side wall 50 is not a flat surface. Instead, the front side wall 50 forms an elongated gripping channel 60. The elongated gripping channel 60 extends through the frame segment 200 from the first end 10 to the second end 20.

In the gripping channel 60, there is a pair of spaced-apart surfaces: an internal front surface 51 and an internal back surface 52. The internal front surface 51 and internal back surface 52 extend between the first end 10 and second end 20 along the longitudinal axis of segment 210a. The gripping channel 60 also has an internal connecting surface 53a that connects the internal front surface 51 and internal back surface 52. Three clip-shaped abutments 54a-54c are provided in the gripping channel 60, one on each of the three internal surfaces 51, 52, 53a. Optionally, in some embodiments, each of the clip-shaped abutments 54a-54c can be capable of receiving and retaining an elongated resilient gasket 55a-55c. With or without elongated resilient gaskets 55a-55c inserted into the clip-shaped abutments 54a-54c, the horizontal segment 210 can receive and retain a piece of material 204, to secure the piece of material 204 in place. In this way, the piece of material 204 is “sandwiched” or “gripped” by the gripping channel 60. Internal connecting surface 53a differs from internal connecting surface 53 in FIG. 2 in that it is broken by thermal break strip 56, which limits thermal conduction from one side of surface 53a to the other. Furthermore, it should be understood that material 204 may be thicker when used in exterior applications that require a thermal break. For example, material 204 may be a thicker glass panel than that used in FIGS. 2 and 3. For example, it may be a 1″ thick double-paned glass panel designed to lower thermal transmission, such as by being filled with argon between the panes.

In some embodiments, the clip-shaped abutments 54 and the elongated resilient gaskets 55 extend from the first end 10 all the way to the second end 20, having substantially the same length as the gripping channel 60. In other embodiments, the elongated resilient gaskets 55 may be shorter, and there may be several segments of elongated resilient gaskets 55 within the clip-shaped abutment 54. In other embodiments, one or more of the clip-shaped abutments 54 may be formed by several clip-shaped abutments in series and spread out along the internal surfaces 51, 52 and/or 53a, each retaining an elongated resilient gasket 55 of substantially the same length.

When installed in this location on a horizontal segment 210 used for the top of a trimless door, the elongated reinforcement bar 90e can provide reinforcement, similar to reinforcement bar 90, as mentioned above with respect to FIG. 2. illustrates multiple locations at which elongated reinforcement bars 90 can be used for reinforcement. Reinforcement bar 90e differs in that it is formed to receive and hold a gasket strip 96, which forms a seal with door jamb 98 to provide an additional thermal barrier.

FIG. 12 illustrates a trimless vertical segment 220a, which is similar to segment 220 in FIG. 3 with a thermal break and has a similar structure to that of the trimless horizontal segment 210a, as illustrated and discussed with respect to FIG. 11. Vertical segment 220a has an elongated back side wall 80 that can extend between the first end 10 and the second end 20 along a longitudinal axis (perpendicular to the page). The elongated back side wall 80 connects and thereby seals the front wall 30 to the back wall 40 on the open side 203, forming an internal reinforcing channel 81.

In some embodiments, the internal reinforcing channel 81 can include an elongated reinforcement member 90d (not shown but see equivalent structure in FIG. 3) along the back side wall 80 and reinforcement member 90c (see equivalent structure in FIG. 3) to support channel 60. Reinforcement members are made from a material suitable for the functions of the member, as described throughout, including complying with local building codes. For example, steel may be used for reinforcing the stiles, particularly around hinges and locks. In some embodiments, reinforcing members can be thermally isolated from the door frame components by placing a polymer gasket strip between interfacing surfaces. For example, in FIG. 3, a thin (e.g., 1-2 mm) insulating polymer strip can be sandwiched between surfaces 93 and 94 and surfaces 30 and 40, respectively (and optionally between surfaces 95 and 80). This can minimize thermal conductivity from one side of a door to the other when a metal reinforcement member is used.

Trimless vertical segment 220a (FIG. 12) differs from trimless vertical segment 220 (FIG. 3) in that it includes thermal break strips to minimize thermal conductivity between walls 30 and 40 and a door seal to minimize airflow between the door and the jamb. Like in FIG. 11, thermal break strip 56a bisects internal surface 53a on the side of gripping channel 60 to minimize conductivity between walls 30 and 40. Similarly, thermal break strip 74a bisects backside wall 80a. Thermal break strip 56a breaks up internal surface 53a of gripping channel 60, while thermal break strip 74a breaks up wall 80a. Together these create a thermal break in horizontal segment 210a. In some embodiments, the void 81 between surface 53a and wall 80a can be filled with an insulating foam. Wall 80a also includes a gasket 96a (polymer strip or brush) to seal the air gap between wall 80a and vertical jamb 98a. In this manner, thermal conduction and air intrusion can be minimized for exterior door applications.

In some other embodiments, any materials may be used as the piece of material that is being retained or sandwiched by the segments of present disclosure, to meet specific needs, such as for having additional reinforcements, for reducing the overall costs, or for a wish to use eco-friendly alternatives. For example, materials like wood, steel, ultra-dense plastic, recycled plastic, or recycled car tires may be used. Similarly, it's to be understood that specific dimensions of the door and the glass, and the hardware cutouts may also vary to meet different needs. For example, different sizes of gaskets may be used to secure the glass in place.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

In some alternative implementations, the functions noted in the blocks of the flowcharts herein can occur out of the order noted in the figures. For example, two blocks shown in succession can, in fact, be executed substantially concurrently, or the blocks can sometimes be executed in the reverse order, depending upon the functionality involved.

A second action can be said to be “in response to” a first action independent of whether the second action results directly or indirectly from the first action. The second action can occur at a substantially later time than the first action and still be in response to the first action. Similarly, the second action can be said to be in response to the first action even if intervening actions take place between the first action and the second action, and even if one or more of the intervening actions directly cause the second action to be performed. For example, a second action can be in response to a first action if the first action sets a flag and a third action later initiates the second action whenever the flag is set.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods or materials, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

I claim:

1. A trimless frame assembly for retaining a panel, the trimless frame assembly comprising:
a plurality of trimless frame segments, each comprising an elongated front wall, an elongated back wall substantially parallel to the elongated front wall, and a gripping assembly in between the elongated front wall and elongated back wall, the gripping assembly comprising:
a gripping channel comprising a plurality of spaced-apart internal surfaces, and
a plurality of clip-shaped abutments, each on a respective one of the plurality of spaced-apart internal surfaces such that a side of a panel can be received and gripped by the plurality of clip-shaped abutments; and
a panel having a plurality of sides, each of the plurality of sides within a respective gripping channel of a respective one of the plurality of trimless frame segments,
wherein the elongated front wall and the elongated back wall of each of the plurality of trimless frame segments are thermally separated by at least one thermal break strip.

2. The trimless frame assembly of claim 1, wherein the plurality of spaced apart internal surfaces comprises:
an internal front surface spaced-apart from and substantially parallel to the elongated front wall;
an internal back surface spaced-apart from and substantially parallel to the elongated back wall; and
an internal connecting surface connecting the internal front surface to the internal back surfaces.

3. The trimless frame assembly of claim 1, wherein the plurality of trimless frame segments comprise a top segment and a bottom segment, each comprising:
an internal intermediate wall connecting the elongated front wall to the elongated back wall such that an elongated channel is formed by the elongated front wall, the internal intermediate wall, and the elongated back wall.

4. The trimless frame assembly of claim 3, further comprising:
a rod proximate the bottom segment to about which the bottom segment can pivot such that the trimless frame assembly forms a swinging door.

5. The trimless frame assembly of claim 3, wherein the top segment forms therethrough a hardware aperture, the trimless frame assembly comprising:
an elongated reinforcement bar in the top segment between the elongated front wall and the elongated back wall,
a hardware component connected to the elongated reinforcement bar at the hardware aperture.

6. The trimless frame assembly of claim 5, wherein the hardware component is one of a door opener and a door closer.

7. The trimless frame assembly of claim 1, wherein the plurality of trimless frame segments comprises a left segment and a right segment, each comprising:
an elongated back side wall connecting the elongated front wall to the elongated back wall.

8. The trimless frame assembly of claim 7, wherein the left segment forms therethrough a hardware aperture, the trimless frame assembly comprising:
an elongated reinforcement bar in the left segment between the elongated front wall and the elongated back wall,
a hardware component connected to the elongated reinforcement bar at the hardware aperture.

9. The trimless frame assembly of claim 1, wherein the at least one thermal break strip comprises a strip of polyamide.

10. The trimless frame assembly of claim 1, wherein the at least one thermal break strip comprises at least a strip of polyamide in the grip channel.

11. The trimless frame assembly of claim 8,
wherein the plurality of trimless frame segments further comprises a top segment and a bottom segment, each comprising an internal intermediate wall connecting the elongated front wall to the elongated back wall such that an elongated channel is formed by the elongated front wall, the internal intermediate wall, and the elongated back wall,
wherein the top segment is connected to a respective first end of the left segment and the right segment, and
wherein the bottom segment is connected to a respective second end of the left segment and the right segment.

12. The trimless frame assembly of claim 1, wherein each of the plurality of trimless frame segments is made of a single piece of material.

13. The trimless frame assembly of claim 1, wherein each of the plurality of trimless frame segments comprise aluminum and the panel comprises glass.

14. The trimless frame assembly of claim 1, further comprising a plurality of gaskets, each of the plurality of gaskets within a respective one of the plurality of clip-shaped abutments.

15. A trimless frame segment for retaining a panel, the trimless frame segment comprising:
an elongated front wall;
an elongated back wall substantially parallel to the elongated front wall;
at least one thermal break strip thermally separating the elongated front and back walls; and
a gripping assembly in between the elongated front wall and elongated back wall, the gripping assembly comprising:
a gripping channel comprising a plurality of spaced-apart internal surfaces, and
a plurality of clip-shaped abutments, each on a respective one of the plurality of spaced-apart internal surfaces such that a side of a panel can be received and gripped by the plurality of clip-shaped abutments.

16. The trimless frame segment of claim 15, further comprising:
a plurality of gaskets, each of the plurality of gaskets within a respective one of the plurality of clip-shaped abutments.

17. The trimless frame segment of claim 15, wherein the plurality of spaced apart internal surfaces comprises:
an internal front surface spaced-apart from and substantially parallel to the elongated front wall;
an internal back surface spaced-apart from and substantially parallel to the elongated back wall; and
an internal connecting surface connecting the internal front surface to the internal back surfaces.

18. The trimless frame segment of claim 15, further comprising:
an internal intermediate wall connecting the elongated front wall to the elongated back wall such that an elongated channel is formed by the elongated front wall, the internal intermediate wall, and the elongated back wall.

19. The trimless frame assembly of claim 15, wherein the at least one thermal break strip comprises a strip of polyamide.

20. The trimless frame assembly of claim 15, wherein the at least one thermal break strip comprises at least a strip of polyamide in the grip channel.
